(19) United States
(12) Patent Application Publication
(10) Pub. No.: US 2022/0225174 A1
(43) Pub. Date: Jul. 14, 2022

(54) EXPERIENCE-DRIVEN NETWORK (EDN)

(71) Applicant: MOTOJEANNIE, INC., Santa Clara, CA (US)

(72) Inventor: Ayush SHARMA, Cupertino, CA (US)

(73) Assignee: MOTOJEANNIE, INC., Santa Clara, CA (US)

(21) Appl. No.: 17/389,140

(22) Filed: Jul. 29, 2021

Related U.S. Application Data
(60) Provisional application No. 63/135,107, filed on Jan. 8, 2021.

(51) Int. Cl. H04W 28/26; H04W 28/20; H04W 72/12

(52) U.S. Cl. CPC H04W 28/26; H04W 72/1236; H04W 28/20

(57) ABSTRACT

An Experience-Driven Network (EDN) and a corresponding method are disclosed herein. The EDN comprises a user equipment (UE) configured to transmit a request for network resources required by an application being executed on the UE. The EDN further comprises a multi-edge computing (MEC) orchestrator configured to determine a requirement and an availability of the network resources required by the application and select a deployment template based on the determination. The EDN also comprises a virtual infrastructure manager (VIM) configured to create, based on the deployment template, an instance of a user plane function (UPF) corresponding to the application, in an edge site of the EDN. The EDN further comprises a platform manager to deploy the created instance of the UPF in the EDN.

### CROSS REFERENCE TO RELATED APPLICATIONS

This application claims the benefit of U.S. Provisional Patent Application Ser. No. 63/135,107, titled “Application Aware Network”, filed on Jan.8, 2021, which is assigned to the assignee hereof and hereby, expressly incorporated by reference herein.

### FIELD OF THE INVENTION

The embodiments discussed in the present disclosure are generally related to field of both cellular and Wireless Fidelity (Wi-Fi) communication networks. In particular, the embodiments discussed are related to an Experience-Driven Network™ (EDN). More specifically, this invention is relevant in, but not limited to, both private cellular networks and/or wireless fidelity (Wi-Fi) networks as well as public telecommunication-based 4^{th} Generation (4G) and 5^{th} Generation (5G) networks that are built using cloud-native architectures.

### BACKGROUND OF THE INVENTION

Typical communication networks are designed and deployed according to existing technologies in a way that makes them agnostic to specific applications or services that an end user may use. During the initial phases of development in communication networks and associated technologies, this approach was suitable because not many applications or services were available for the end user. Majority of the telecommunication operators were providing triple play or quad play services along with voice call services. In such scenarios, a network may not have needed awareness of the application it was servicing.

Since the deployment and configuration of existing networks are not application specific, such networks cannot satisfy the specific requirements of individual applications. Additionally, since 5G technology of the 3^{rd} Generation Partnership Project (3GPP) includes several use-cases with varied resource requirements, application agnostic networks may not be suitable anymore for a satisfactory experience. For instance, if there is a new application supported by 5G networks such as virtual reality (VR) gaming, VR streaming, VR meditation and so on, the resource allocation for the application may not be optimized in currently available solutions because even a slight latency or lack of resources may lead to poor user experience and content consumption.

### SUMMARY OF THE INVENTION

Embodiments of an EDN and a corresponding method are disclosed that address at least some of the above challenges and issues.

In accordance with an embodiment, a communication network is disclosed. The communication network includes a user equipment (UE) configured to transmit a request for network resources required by an application being executed on the UE. The communication network further includes a multi-edge computing (MEC) orchestrator configured to determine a requirement and an availability of the network resources required by the application and select a deployment template based on the determination. The communication network also includes a virtual infrastructure manager (VIM) configured to create, based on the deployment template, an instance of a user plane function (UPF) corresponding to the application, in an edge site of the communication network. The communication network further includes a platform manager to deploy the created instance of the UPF in the communication network.

In accordance with yet another embodiment, an MEC apparatus is disclosed, that includes a processor and a memory storing computer-executable instructions that when executed, cause the processor to receive, from a UE, a request for network resources required by an application being executed on the UE. The instructions further cause the processor to determine a requirement and availability of the network resources required by the application and select a deployment template based on this determination. The instructions further cause the processor to create, based on the deployment template, an instance of a user plane function (UPF) corresponding to the application, in an edge site in proximity to the UE and deploy the created instance of the UPF in a communication network associated with the MEC apparatus.

### BRIEF DESCRIPTION OF THE DRAWINGS

Further advantages of the invention will become apparent by reference to the detailed description of preferred embodiments when considered in conjunction with the drawings:

FIG. 1 illustrates a flowchart representing a method for network resource management for an application in a communication network in accordance with an embodiment.

FIG. 2(a) illustrates a high-level diagram of a communication network in accordance with an embodiment.

FIG. 2(b) illustrates a detailed diagram of the communication network in accordance with an embodiment.

FIG. 3 illustrates a block diagram of an exemplary computer system, in accordance with an embodiment.

FIG. 4 illustrates a signal flow diagram illustrating the functions performed by various entities in the communication network, in accordance with an embodiment.

FIG. 5 illustrates a privatized communication network, in accordance with an embodiment.

FIG. 6 illustrates an exemplary scenario of a privatized communication network, in accordance with an embodiment.

FIG. 7 illustrates multiple communication networks connected with a common cloud service, in accordance with an embodiment.

FIG. 8 illustrates a relationship between Lounge-X™ and Edge-™ platforms, in accordance with an embodiment.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown but is to be accorded the widest possible scope consistent with the principles and features disclosed herein.

Certain terms and phrases have been used throughout the disclosure and will have the following meanings in the context of the ongoing disclosure. For purposes of explanation, the term “MEC orchestrator” (also referred to as “Dynamic control” in this disclosure) is responsible for overall control of the network resource management, in the manner described in this disclosure. Additionally, the “MEC orchestrator” along with an “MEC platform”, as disclosed in further sections of the disclosure, may collectively be referred to as “Edge-X™”. The Edge-X™ may, however, include one or more additional components that may be included in an edge- site, as described later in this disclosure. Here, the terms “MEC host” and “MEC platform” are used interchangeably in the disclosure. The MEC host may refer to the physical infrastructure (e.g. servers, processors, memory devices and so on) that hosts the MEC platform but may be considered interchangeable, in accordance with the embodiments presented herein. In some embodiments, the MEC host may include a data plane, the MEC platform and one or more MEC applications that are deployed on the MEC platform by a MEC platform manager. The overall task of the MEC host is to collect data, either the data traffic via data plane or specific data for deployed applications. Once data is transferred to the deployed applications, the MEC host may perform the required processing and send the data back to a respective source of data.

Further, the “Edge-X™” may have the capability of interacting with third-party applications and supporting additional features provided by such applications. These features may include one or more of, but not limited to, play prediction, sports betting, AR-based 3-dimensional (3D) image rendering, context aware advertisements, and/or data overlay.

Further, a User Equipment (UE) may implement a software-based platform called “Lounge-X™” to run one or more latency-sensitive applications that may need resource management, in accordance with an embodiment. Additionally, the “Lounge-X™” platform may be adapted to be implemented on any type of UE such as, but not limited to, a smartphone, a tablet, a phablet, a laptop, a desktop, a smartwatch, a smartphone mirrored on a television (TV), a smart TV, a drone, an AR/VR device, a camera recording an event in a stadium, a sports equipment with on-board sensors, or a similar device that is capable of being operated by the user, in the communication network. In one example, Lounge-X™ may be a personalized digital lounge on user's UE to enhance user experience while using various latency-sensitive applications. Further, Lounge-X™ can be installed on any Android®, iOS®, Unity™-based devices, or any other mobile operating system

Further, a latency-sensitive application may be based on an augmented reality (AR), a virtual reality (VR), and/or a mixed reality (MR) technology platform. The application may be, but not limited to, an interactive streaming application, a gaming application including an interactive gaming application or a cloud gaming application, or a remote rendering application such as an Industrial Internet of Things (IIoTs) application, a connected cars application, a holographic view application, and a haptics-based application. In one non-limiting example, Lounge-X™ may facilitate a virtual presence of a celebrity in the vicinity of the user using an MR-based application. In another non-limiting example, Lounge-X™ may facilitate VR-based custom face masks in a VR-based application. In yet another non-limiting example, Lounge-X™ may facilitate play prediction in a gaming application.

Further, “Edge-X™” may imply deployment of an application on the network end, while “Lounge-X™” may imply the execution of the application at the UE end. This implies that the applications that are executed on the UE by the user, using the “Lounge-X™”, may be deployed on the “Edge-X™”. Both “Edge-X™” and “Lounge-X™” may be in communication with each other through a “control loop”. In one example, the “control loop” may not necessarily be a physical entity but a virtual or logical connection, via which, at least some functions of the “Lounge-X™” may be managed by “Edge-X™”. In another example, the control loop may be a feedback mechanism between the Lounge-X™ at one end and Edge-X™ and Cloud-X™ at the other end. Here, the term “Cloud-X™” may include a proprietary or third-party cloud service for storing one or more of, but not limited to, data planes, control planes/functions, and 5G core network components. In an embodiment, “Lounge-X™” constantly monitors and manages the user experience by communicating the resource needs of a resource-intensive application to “Edge-X™” through the “control loop”. The embodiments of this disclosure enable such resource-intensive applications on the UE to seamlessly run and enhance the user experience without any incumbrances to the user in watching the streamed content.

However, the above terms and definitions are provided merely to assist a reader in understanding the invention in a better manner and do not limit the scope of any functionality. Additionally, the terms “communication network”, “communication networks”, “networks”, and “network” are used interchangeably for brevity and a better understanding of the disclosure. Additionally, the terms “network resources” and “resources” are interchangeably used throughout this disclosure and may encompass one or more of, but not limited to, resources related to 3 C′s of Next Generation network communication—Content, Compute, and Connectivity. Here, Content-based resources may include content delivery networks (CDNs) for providing content to a user using the UE. Further, Compute-based resources may include an edge-based infrastructure (e.g. Edge-X™) that may be used in the network to increase compute flexibility of the network. Additionally, Connectivity-based resources may include network slicing, which may be used for seamless connectivity between the user and the network. Additionally, the network resources may also include frequency, time, bandwidth, data rate or throughput, processing power requirements, connection interface requirements, graphic and/or display capabilities, and storage requirements.

Additionally, various components discussed in this disclosure, such as UE(s), proxy node(s), MEC orchestrator, MEC platform manager, virtual infrastructure manager (VIM), virtualization infrastructure, MEC platform and base stations (gNodeBs) may include dedicated processors and storage devices. Additionally, each of these components may either be implemented as hardware or software modules. One or more of these components may even be implemented as a combination of hardware and software modules or as simulations in a virtual environment. Additionally, the terms “template” and “deployment template” are used interchangeably in this disclosure and may imply a software module or description of deployment specifications of various components in the communication network.

In some embodiments, network slicing may be used in combination with load balancing between a cellular (e.g. 5G) network and a Wi-Fi (e.g. Wi-Fi 6) network to provide seamless connectivity to a user. Further, the requirements of the latency-sensitive applications disclosed in the embodiments of this disclosure, may be higher as compared to conventional networks or technologies and may accordingly, be satisfied by the disclosed embodiments. Further, the disclosed approaches are directed towards resource-intensive applications that are present in or will be introduced in 5G networks. As a consequence of the disclosed embodiments, the user experience is expected to be immersive, fluid, and dynamic by minimizing latency in the network. This minimization of latency, in accordance with the embodiments presented herein, may be referred to as Latency-As-A-Service™ (LaaS), in one example.

In conventional technologies related to slicing communication networks, a communication network is sliced on a service layer of a communication network, that is, the communication network is sliced based on the services deployed in that network. This approach does not optimally anticipate resource requirements of specific applications, which may introduce scalability issues in the network when newer applications are introduced to operate in the network.

The concept of network slicing was defined by 3GPP and introduced to dedicate a slice of bearer channel for specific applications. This invention extends beyond the known concepts and brings network slicing and load balancing across diverse use-cases, as described later in this disclosure. For instance, the embodiments result in network slicing along with load balancing between Wi-Fi and private LTE networks and/or between Wi-Fi 6 and private 5G networks. These networks may be located in, but not limited to, a stadium, a hospital, or an institution or any other premises. Additionally, the feedback mechanism called “control loop” brings automation, elasticity, and self-optimization ability to network slicing by providing application-specific feedback on the resource requirements to the network to optimize network resources allocated to the applications running on the UE. The embodiments described herein are explained with reference to 5G networks but may also be implemented for any other type of network.

Additionally, in the existing technologies, there is no elasticity in the network slicing in terms of automatic adjustment of bandwidth, latency, jitter, compute allocation management. The network slices are configured as a one-time activity and lack the capability to dynamically adjust themselves according to varying resource requirements of applications. For instance, in a sports environment, where sports fans enjoy interactive streaming experiences and new holographic, AR, or where overlay data-specific experience is introduced, the existing slicing solutions may lead to a poor or compromised experience.

Further, the present disclosure provides a communication network (e.g. an EDN) that is aware of the application(s) that the network is serving. Thus, one object of the disclosure is to create the EDN to fulfill the respective requirements demanded by the applications to ensure a fluid user experience. For instance, in some embodiments, an application-specific slice may be created instead of a service-specific slice for a service such as enhanced Mobile Broadband (MBB) or any other high-level service offered by 5G networks. Thus, taking the resource requirements of each application into consideration enables the network to take a unified decision regarding slicing the network based on such requirements (of each application) instead of slicing it based on the high-level services deployed in the network. Another object of this disclosure is to create a separate user plane function (UPF) corresponding to each application depending on the resource requirements of that application. The UPFs may additionally, by dynamically created based on varying application requirements in terms of the resources required for such applications provide a seamless user experience.

In some embodiments, in order to achieve application awareness in the network, the way the network is deployed, configured and re-configured, may be adapted based on a feedback from, but not limited to, applications that are running on the UE and deployed over the MEC platform, as disclosed herein. In these embodiments, for each application, a separate data plane may be created while the control plane may be common at a centralized location.

Embodiments of this disclosure present a method for network resource management for an application in a communication network. The method includes determining a requirement and an availability of network resources for the application and selecting a deployment template based on this determination. The method further includes creating, based on the deployment template, an instance of a user plane function (UPF) corresponding to the application, in an edge site of the communication network. The method further includes deploying the created instance of the UPF in the communication network.

Embodiments of the above-described method further include receiving, from the UE via a lifecycle management (LCM) proxy node, a request for network resources required by the application. The embodiments further include determining a requirement and an availability of the network resources and selecting the deployment template based on determining the requirement and the availability of the network resources. The embodiments of the method further include selecting the edge site based on one or more of a proximity of the edge site to the UE, the availability of the network resources on the edge site, and a hardware requirement of the application. Here, determining the availability of the network resources includes determining the availability of the network resources in the edge site based on a mapping between one or more applications and their resource requirements.

Further, selecting the deployment template based on the determination includes selecting the deployment template if it is determined that the network resources are available and sending an error message to the UE, if it is determined that the network resources are not available.

In accordance with these embodiments, the deployment template includes an application descriptor (AppD) that indicates the network resources required by the application. The template further includes a virtual network function description (VNFD) that indicates one or more parameters that define a configuration and deployment specification of a virtual network function (VNF) associated with the VNFD, one or more parameters that define a configuration and deployment specification of the instance of the UPF, and one or more configuration parameters for one or more nodes in the communication network. The embodiments further include configuring the one or more nodes based on a virtual network function descriptor (VNFD) corresponding to the VNF.

These embodiments further include establishing networking between one or more nodes in the communication network, wherein establishing the networking comprises connecting each of the created instances of the UPFs to the one or more nodes to enable a UE executing the application to access the UPFs. The embodiments additionally include performing an analysis of usage patterns and resource utilization of the application using one or more of an Artificial Intelligence (AI)/Machine Learning (ML) models and providing one or more contextual content recommendations based on the usage patterns. The embodiments further include reconfiguring one or more of the one or more nodes based on the created application to resource mapping.

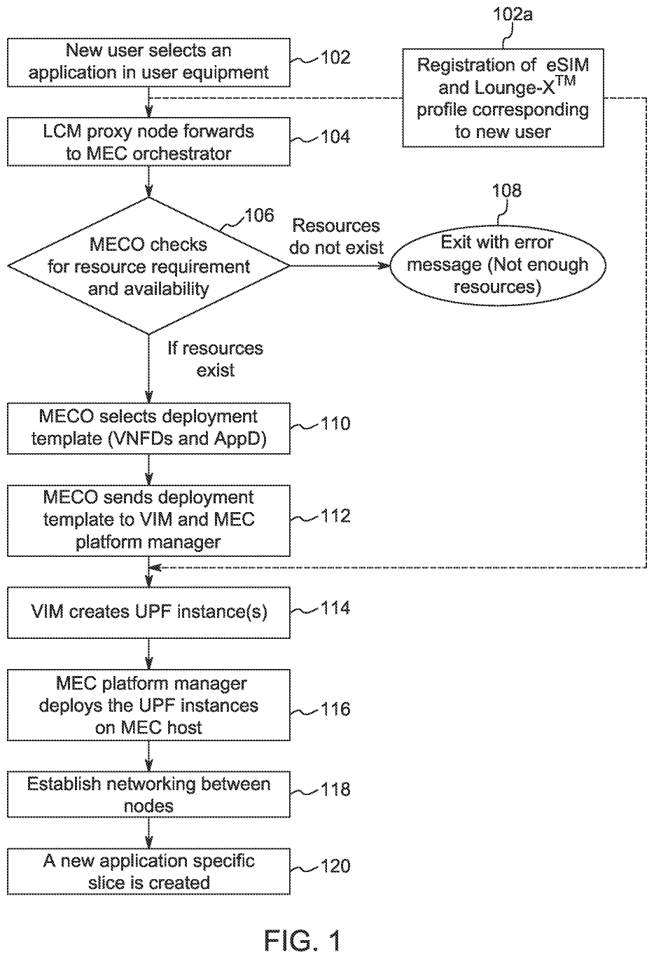

These and other embodiments of the methods and systems are described in more detail with reference to FIGS. 1, 2a, 2b, 3, 4, 5, 6, 7, and 8, as follows.

FIG. 1 illustrates a flowchart for a method for network resource management for an application, in a communication network in accordance with the embodiments of this disclosure. The application is being executed in a UE on the Lounge-X™ platform, which may allow the user to interact with one or more 5G-based applications, in an example. The UE may be in communication with the network. The objective of this method is to create an application specific network slice to satisfy resource requirements of the application.

In step 102, a new user may select an application on the UE. In one example, the Lounge-X™ platform may display several applications to the user on a display screen of the UE. The applications may be displayed once the user provides an input to the Lounge-X™ platform via a “Lounge-X™” icon displayed on the UE. The input may be but not limited to, a touch input or gesture, a voice command, an air gesture, or an input provided via an electronic device such as, but not limited to, a stylus, keyboard, mouse and so on. Once the Lounge-X™ platform displays the associated applications, the user may be able to interact with the Lounge-X™ platform and select one of the displayed applications, that the user intends to run/execute on the UE.

In one example, the user may not be previously registered with the network (Edge-X™). Therefore, the user may need to register themselves with the network by using an embedded subscriber identity module (eSIM) in order to use the Lounge-X™ application and communicate with the network. Here, the UE may include one or more Lounge-X™ profiles. Each profile may correspond to an associated user and a corresponding eSIM belonging to that user. Further, each of these profiles may include content preferences of the associated user. Here, the UE may support multiple eSIMs and each eSIM may need to be registered with the network for authenticating its associated user for communicating with the network.

In one example, when the user installs the Lounge-X™ application for the first time on the UE, the UE may display a Lounge-X™ based user agreement to register the associated eSIM with the network. Here, the Lounge-X™ application may not have been previously deployed on the Edge-X™. Once the user accepts the agreement, the eSIM and the corresponding Lounge-X™ profile may be registered with the network (Edge-X™) in step 102a. The step 102a may occur once the user selects the application. However, this step may occur in parallel to and independent of steps 104-114 (described later) of FIG. 1.

When the user uses the Lounge-X™ application using the same eSIM at subsequent instances, the network authenticates the user based on the registered eSIM, for further communication. The above-described registration and/or authentication procedure may be performed by a MEC orchestrator in the network, in one example. However, a person skilled in the art would understand that any entity in the network may perform the above-described registration and/or authentication procedure and the disclosure is not limited to the MEC orchestrator performing this procedure.

In other examples of legacy devices that may not support the eSIM functionality, internet-based user credentials may be used to authenticate a user by enabling the network to identify a user-specific Lounge-X™ profile associated with the user. For instance, a user may enter a username and a password for authentication. In some cases, multi-factor authentication or biometric authentication may be used as well. However, a person skilled in the art would understand that the above mechanisms for authentication of a user are only illustrated as examples and any mechanism for authentication of a user and associating the Lounge-X™ profiles with users may be used depending on the implementation requirements.

Further, in step 104, a lifecycle management (LCM) Proxy node may receive an application request from the UE and forward the application request to an MEC orchestrator. Here, this request may be generated as a result of the user selecting the application in step 102. Consequently, the UE may generate the application request and send it to the LCM Proxy Node, which may further send it to the MEC orchestrator. For example, this request may include a request for network resources required by the application that is selected and being executed on the UE.

Further, the MEC orchestrator (MECO) may receive the request sent by the UE via the LCM proxy node and may accordingly, check for resource requirements and their availability for deployment of the selected application in the communication network, in step 106. Further, the MEC orchestrator may determine the availability of the network resources in an edge site (or Edge-X™) that is closest to the UE, that is, the edge site has the highest proximity to the UE. In one example, the network resources may be, but not limited to, hardware related resources related to graphic or display capabilities and storage requirements. In an exemplary scenario, the edge site may also be selected based on one or more service level agreement (SLA) requirements to satisfy a particular application or use-case. In another exemplary scenario, the edge site may be selected based on resource availability on that edge site. In yet another exemplary scenario, special hardware requirements of the application may also be taken into consideration to select an edge site out of a plurality of edge sites.

In some embodiments, the edge site may include, within its premises, edge site infrastructure provided by a cloud provider. The edge site infrastructure may include several components to execute various functions of the edge site. These components, along with their functions, are explained in the following sections of this disclosure.

Referring back to the FIG. 1, if the MEC orchestrator determines that the resources are not available and the resource requirements cannot be satisfied, the method exits with an error message in step 108. For instance, the MEC orchestrator may exit the method by sending a message to the UE that sufficient resources are not available for the application and subsequently, the UE displays an error message indicating that the resources are not available or sufficient resources are not available for the application. Optionally, the UE may display an additional message indicating an approximate time duration after which the resources are expected to be available and suggest that the user may execute the application after that time duration has elapsed.

In some embodiments, the MEC orchestrator may include a list of applications that may potentially be deployed in the communication network. When an application is launched/introduced to the network, it may be registered with the MEC orchestrator and the MEC orchestrator may accordingly, create a mapping of the application name with the resources required by that application. In some embodiments, the determination of the availability of the network resources in the edge site may be based on the mapping between one or more applications and their resource requirements. For instance, the MEC orchestrator may store and maintain this mapping in its memory. When a UE requests resources for the application, the MEC orchestrator may check the mapping and accordingly determine, whether the available resources are sufficient or not. If sufficient resources are not available, the MEC orchestrator may revert with an error message, as discussed above.

However, if it is determined by the MEC orchestrator that the resources exist (sufficient resources are available), the MEC orchestrator may select a deployment template in step 110. Thus, the deployment template is selected based on the above determination of the requirement and availability of the network resources. The deployment template includes two components—a virtual network function descriptor (VNFD) and an application descriptor (AppD).

Herein, a virtual network function descriptor (VNFD) is a template which includes certain parameters that define how a virtual network function (VNF) may be configured and deployed in the communication network. The AppD is a template that indicates the network resources required by the application that is being executed on the UE.

Here, the VNFD includes configuration and deployment specifications of the VNF. Generally, the VNF may be deployed either manually by a third-party or automatically. Additionally, the VNFD also includes one or more parameters that define a configuration and deployment specification of instances of UPF that need to be created. When the VNF is deployed automatically, the VNFD is required for deploying the VNF. The VNFD includes various parameters and specifications (e.g. configuration and deployment specification) that are required to deploy the VNF associated with the VNFD, along with instructions and/or configuration parameters to configure one or more network elements or nodes such as, but not limited to, base stations (e.g. gNodeBs) in the communication network. In some embodiments, the VNFD may further include one or more configuration parameters of all network nodes in the network. For each VNF that is to be controlled from the MEC orchestrator, there is a corresponding VNFD. Thus, when the VNFD is sent from the MEC orchestrator to the VIM, a corresponding network element or node may be configured based on instructions in the VNFD.

In step 112, the deployment template may be sent by the MEC orchestrator to a virtual infrastructure manager (VIM) and an MEC platform manager. The VIM manages operations of the virtual infrastructure in the edge site. For example, if an operating system and a hypervisor are installed on a server in the edge site and certain virtual machines (VMs) need to be created over the hypervisor, the tasks of VM creation and resource assignment for each VM based on requirements of the MEC orchestrator are performed by the VIM. Further, the MEC platform manager is used to deploy the application(s) on an MEC platform in the edge site. Herein, the step of sending the deployment to the VIM and the MEC platform manager includes the MEC orchestrator sending the VNFD to the VIM and sending the AppD to the MEC platform manager. Once the AppD is sent by the MEC orchestrator to the MEC platform manager, the MEC platform manager understands the resource requirements of the application that needs to be deployed and accordingly, deploys the application(s) in the MEC platform.

In one example, the deployment template may be written in a Topology and Orchestration Specification for Cloud Applications (TOSCA) script. Although the contents of the deployment template may vary as per the vendor who created the template, the deployment template in this example may include: a). Metadata including information related to a network node on which the UPF instance needs to be deployed—name of the node, identity of the node, type of the node, version of the node, and provider name; b). Node specific information such as compute requirements (node name, CPU required, memory required, flavor required, OS required, and storage required); c). Interface requirements (interface name, IP address, virtual network interface card (vNIC) type, and virtual binding); d). Image file details (file URL, container type, file name, disk format, etc.); and e). Local storage details (name, size, and disk type). In accordance with the embodiments of this disclosure, all the above-mentioned parameters may be included in both the AppD and the VNFD. However, the value of each parameter may be different in the AppD and the VNFD.

Further, the VIM may be used to manage virtual infrastructure included in the edge site. For example, if an operating system and a hypervisor are installed on a server and certain virtual machines (VMs) need to be created over the hypervisor, the tasks of VM creation and resource assignment for each VM based on requirements of the MEC orchestrator are performed by the VIM. Here, the VIM may be additionally used to install the VNFs over the created VMs.

In step 114, the VIM may spawn out or create a new instance of a user plane function (UPF) in the edge site based on the VNFD. This instance of the UPF may be specific to the application that is being executed on the UE and forwarded to the MEC orchestrator via the LCM proxy node. Similarly, a separate instance of the UPF may be spawned out for each application that needs to be deployed. In one example, the UPF instance may be created based on the registration and/or authentication of the user. For instance, the MECO may determine if the user using the Lounge-X™ application is registered and/or authenticated with the network as a result of step 102a. If the determination is positive (i.e., the user is registered and authenticated), the MEC orchestrator may provide a corresponding confirmation to the VIM, which may then create a UPF instance based on this confirmation.

In step 116, the created instance(s) of the UPF and the application may be deployed on an MEC host based on the deployment template. The step 116 may include two aspects—first, the MEC platform manager deploys the application(s) on the MEC host (or MEC platform manager) based on the AppD included in the deployment template and second, the VIM deploys individual instances of the UPFs corresponding to each application, on the MEC host (or MEC platform manager) based on the VNFDs corresponding to each application. In some other embodiments, the instances of the UPFs along with the application(s) may be deployed by the MEC platform manager and the VIM may be used to manage the virtual infrastructure depending on the design requirements.

Further, step 118 includes establishing networking between different nodes of the communication network. This step includes establishing a connection of each UPF instance with a base station (gNodeB), via which, the UE can connect to the newly created UPF instances corresponding to each application being executed on the UE. In step 120, a new application specific slice is created based on the created UPF instances. This application specific slice may enable a user of UE to consume content seamlessly, that is, without experience delays despite using resource-intensive applications on the UE. In one example, the application specific slice may correspond to the Lounge-X™ profile associated with the user that is authenticated using the e-SIM. Thus, the application-specific slice may be dedicated for the applications indicated by the Lounge-X™ profile. Additionally, the application-specific slice may be created based on one or more policies specified by the Lounge-X™ profile. The policies may include rules related to resource requirements of the applications such as, but not limited to, Content, Compute, and Connectivity related resources, as described earlier in this disclosure.

In accordance with the embodiments of this disclosure, the following two exemplary scenarios are possible when a user selects an application to execute it on the UE:
1. The selected application is not yet deployed on the edge site.
2. The selected application is already deployed on the edge site.

An objective for the above-mentioned scenarios is that the communication network is set up and the UE is attached to the communication network via a UPF.

The flowchart described in FIG. 1 illustrates the first exemplary scenario. In this scenario, on Day 0 when network setup is initiated, there is no UPF that already exists in the network 200. Therefore, UPFs may need to be created for each application that is to be deployed on the edge site. Thus, when the network setup is completed, the UEs can connect to the network using the created UPFs.

In the second exemplary scenario, the selected application is already deployed on the edge site. In this scenario, the application is already deployed on the edge site. When the user selects the application, a Session Management Function (SMF) may select the nearest edge site based on the user's location. Since a UPF is already created (e.g. from the first scenario), the UE may access the UPF and the user may start accessing the application.

In one example, the method described in the context of FIG. 1 may be divided into a days-based naming convention:
DAY 0 (Software On-Boarding)

Template Creation

Network Nodes Onboarding

Application Onboarding

Infrastructure setup
DAY 1 (Instantiation)

Network setup and deployment based on application
DAY 2 . . . N (Feedback)

Data collection from network nodes

Based on resource usage, re-configuration of node resources

In some embodiments, the method described in the context of FIG. 1 may be supplemented by one or more additional and optional steps. For instance, the MEC orchestrator may perform an analysis of usage patterns and resource utilization of the application mentioned above or any other applications that may be deployed in the communication network in a similar manner. Further, the MEC orchestrator may create an application to resource mapping indicating resource requirements of the application. This mapping may assist an operator to reconfigure any node of the communication network to enhance the performance of the communication network. Alternately, the network may self-reconfigure automatically to alter the operation of any of the nodes in the network based on the mapping.

In some embodiments, various AI or ML based algorithms may be used to determine trends in the usage patterns and resource utilization of the above-discussed applications and improve network performance. The above-mentioned analysis of the usage patterns and resource utilization of the application (e.g. Lounge-X™ or an equivalent application on the UE) may be used, for instance by the MEC orchestrator, to identify usage patterns of the user(s) using the UE(s) by analyzing usage pattern data. This analysis may be further used to personalize experiences of the users as streaming services on the UE. In another example, user location and application usage pattern can be used to enable contextual content recommendations and/or context aware transactions such as relevance-based advertising, merchandizing, food order options and so on. In yet another example, parameters such as traffic patterns, number of users, sessions and so on can be used to further optimize the network and corresponding infrastructure.

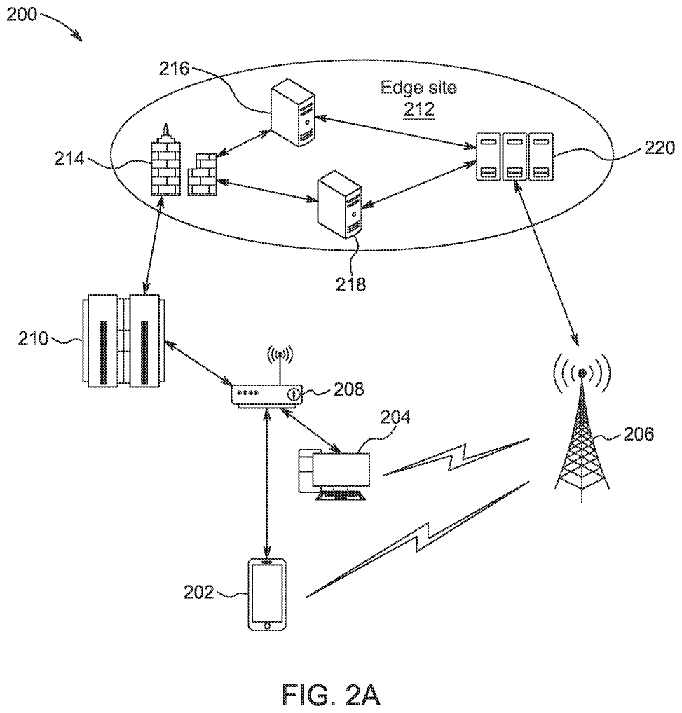

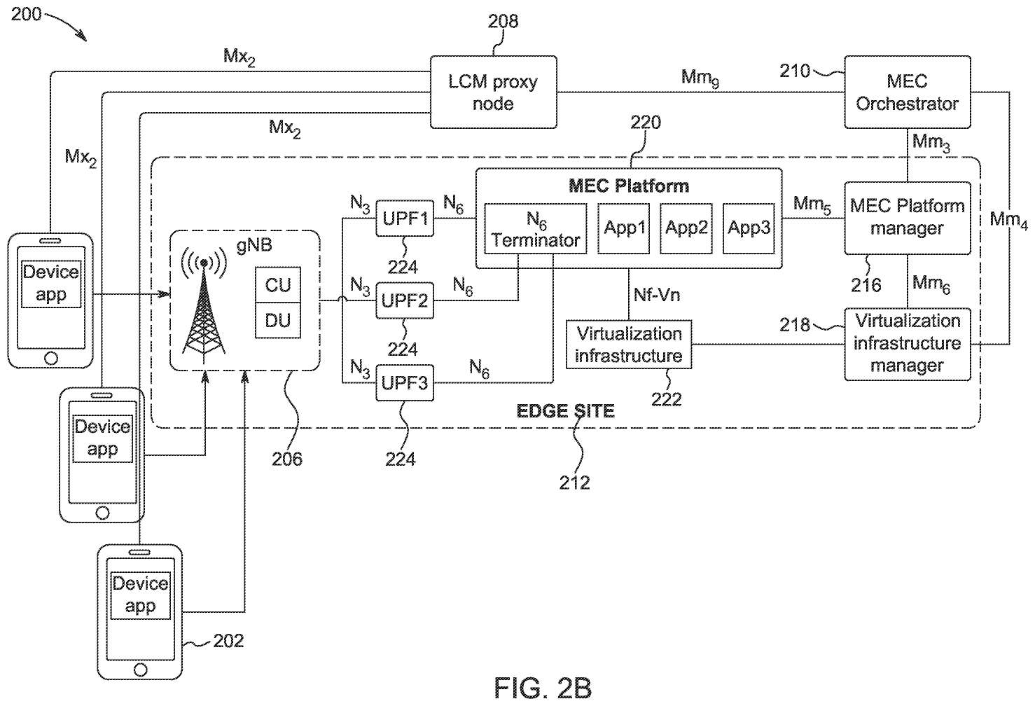

FIG. 2(a) illustrates a high-level diagram of a communication network 200 in accordance with the embodiments of this disclosure. The communication network 200 includes various components such as, but not limited to, UEs 202 and 204, a base station (gNodeB) 206, an LCM proxy node 208, an MEC orchestrator 210, and an edge site 212 (or Edge-X™) that includes a central office 214, an MEC platform manager 216, a VIM 218, and an MEC platform 220. The functions of these components may be similar to the corresponding components described in the context of FIG. 1.

In accordance with some embodiments, any of the UEs 202 and 204 may be in communication with the LCM proxy node 208 and the base station 206. A person skilled in the art would acknowledge that the number and types of UEs are not limited to the above-mentioned UEs and may vary according to the design requirements and/or implementation of the invention.

Further according to the embodiments of the invention, the LCM proxy node 208 may be in communication with the MEC orchestrator 210, which may be in further communication with an edge site 212. As discussed above, the edge site 212 may include edge site infrastructure that may further include the central office 214, the MEC platform manager 216, the VIM 218, and the MEC platform 220. However, the edge site 212 may include fewer or additional components as per the design requirements of the edge site 212 according to the embodiments of this disclosure.

The central office 214 may control other components included in the edge site 212 to execute various functions according to the embodiments of this disclosure. For instance, in some embodiments, the central office 214 may be in communication with the MEC orchestrator 210 as well as with the MEC platform manager 216 and the VIM 218. Depending on the messages received from the MEC orchestrator 210, the central office 214 may issue instructions to the MEC platform manager 216 and the VIM 218 to execute desired tasks, in accordance with the embodiments of this disclosure.

In some other embodiments (not shown), the central office 214 may not be located within the edge site 212 and may be located at a remote location. In yet some other embodiments, there may not be any central office 214 to control the components of the edge site 212. The MEC platform manager 216 and the VIM 218 may be in direct communication with the MEC orchestrator 210 and accordingly, execute desired tasks based on computer-executable instructions pre-loaded either within the MEC platform manager 216, VIM 218 or the MEC orchestrator 210.

Further, according to the above-discussed embodiments, the MEC platform manager 216 may deploy one or more applications on the MEC platform 220. These applications may be the same applications that are being executed on the UE.

Further, the VIM 218 may use virtual network infrastructure (not shown) to deploy one or more virtual network functions (VNFs) in the MEC platform 220, using an Nf-Vn interface. The MEC platform 220 may further be in communication with the base station 206 to enable the UEs 202 and 204 to access various UPFs corresponding to the applications being executed on the UE 202 and/or UE 204, according to the embodiments of this disclosure.

A person skilled in the art would acknowledge that any of the above-mentioned components or entities may be in direct or indirect communication with each other and the mere description of the embodiments of this disclosure does not, in any way, restrict any component in the communication network 200 to interact with any other component of this communication network 200.

FIG. 2(b) illustrates a detailed block diagram that represents various components of the communication network 200 in accordance with the embodiments of this disclosure and earlier illustrated in FIG. 2(a). The functions of components illustrated in FIG. 2(b) may be similar to the functions of the corresponding components illustrated in FIG. 2(a) and described in the context of FIG. 1.

Here, one or more UEs (e.g. UE 202) may be connected to the LCM Proxy node 208 via an M×2 interface. The LCM proxy node 208 may be connected to the MEC orchestrator 210 via an Mm9 interface. The MEC orchestrator 210 may be connected to the MEC platform manager 216 of the edge site 212, via an Mm3 interface. The MEC orchestrator 210 may be connected to the VIM 218 of the edge site 212, via an Mm4 interface.

Further, the MEC platform manager 216 may be connected to the MEC platform 220, which may be a part of the MEC host. Here, MEC platform manager 216 may deploy the application(s) selected on a UE 202 on the MEC platform 220 via an Mm5 interface, in the manner described in the context of FIG. 1. Further, the VIM 218 may use virtual network infrastructure 222 (or virtualization infrastructure) to deploy the one or more virtual network functions (VNFs) in the MEC platform 220, using an Nf-Vn interface. Further, the MEC platform 220 may include an N6 Terminator interface that may connect the MEC platform 220 to one or more UPFs 224 such as UPF1 224, UPF2 224, UPF 3 224, and so on. These UPFs are created in accordance with the method described in the context of FIG. 1. The UE 202 may connect to one or more of these UPFs via the gNodeB 206. Here, the gNodeB 206 may include a control unit (CU) and a data unit (DU), as known the art. Further, the UPFs 224 may be connected to each other via an N3 interface.

Since separate UPFs 224 are created for each application, embodiments of this disclosure enable better understanding of user behavior and resource utilization over a period of time, for each application. This in-turn provides a service to resource mapping for a network operator, which can be used to optimize the network in accordance with the embodiments of this disclosure. For example, the resources required for the VR meditation application may be different from the resources required for the VR gaming application.

However, the existing networks prior to this disclosure, distinguish the allocation of resources at the service level instead of at the application level. This implies that in the above example, VR related applications like streaming, gaming, conferencing and so on fall under VR services, and therefore, resources are created based on VR as a service and not based on specific VR applications under such a VR service.

Once resource requirements for the applications are understood, it assists in capacity planning of a new network and resource optimization. The embodiments of this disclosure also enable the network to provide a personalized experience to the user by fulfilling resource requirements of individual applications.

Based on the optimum value, the configuration template for that application may be updated, and be sent to the network 200, as a part of Application-specific slicing.

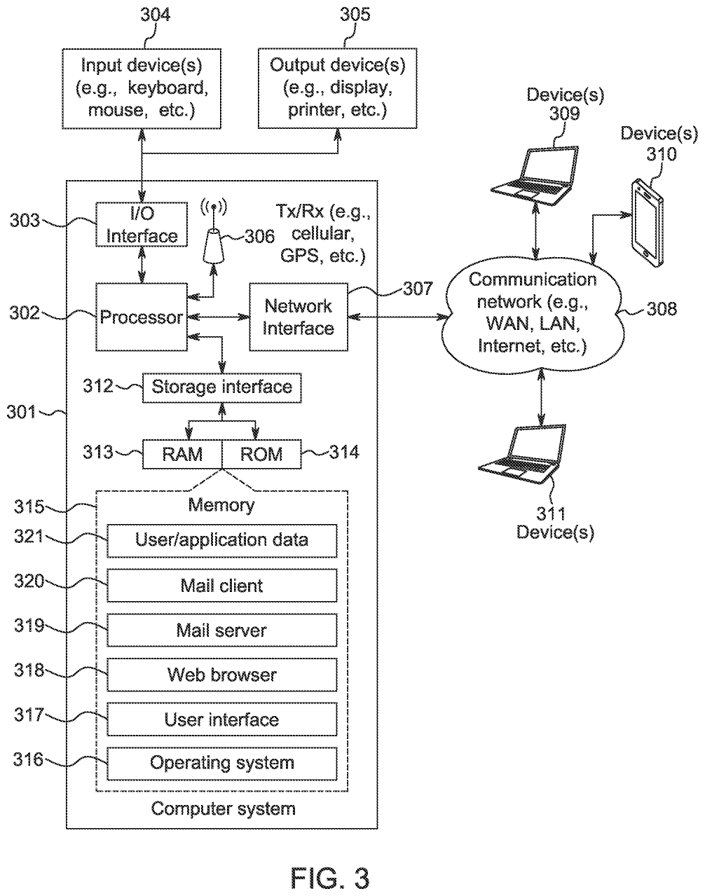

FIG. 3 is a block diagram of an exemplary computer system for implementing embodiments consistent with the present disclosure. Variations of computer system 301 may be used for implementing list of all computers from other figures. Computer system 301 may include a central processing unit (“CPU” or “processor”) 302. Processor 302 may include at least one data processor for executing program components for executing user- or system-generated requests. A user may include a person, a person using a device such as those included in this disclosure, or such a device itself. The processor may include specialized processing units such as integrated system (bus) controllers, memory management control units, floating point units, graphics processing units, digital signal processing units, etc. The processor 302 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 302 may be disposed in communication with one or more input/output (I/O) devices via I/O interface 303. The I/O interface 303 may employ communication protocols/methods such as, without limitation, audio, analog, digital, monaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 303, the computer system 301 may communicate with one or more I/O devices. For example, the input device 304 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 305 may be a printer, fax machine, video display (e.g., cathode ray tube (CRT), liquid crystal display (LCD), light-emitting diode (LED), plasma, or the like), audio speaker, etc. In some embodiments, a transceiver 306 may be disposed in connection with the processor 302. The transceiver may facilitate various types of wireless transmission or reception. For example, the transceiver may include an antenna operatively connected to a transceiver chip, providing IEEE 802.11a/b/g/n, Bluetooth, FM, global positioning system (GPS), 2G/3G HSDPA/HSUPA communications, etc.

In some embodiments, the processor 302 may be disposed in communication with a communication network 308 via a network interface 307. The network interface 307 may communicate with the communication network 308. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 308 may include, without limitation, a direct interconnection, local area network (LAN), wide area network (WAN), wireless network (e.g., using Wireless Application Protocol), the Internet, etc. Using the network interface 307 and the communication network 308, the computer system 301 may communicate with devices 309, 310, 311, and 312. These devices may include, without limitation, personal computer(s), server(s), fax machines, printers, scanners, various mobile devices such as cellular telephones, smartphones, tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 301 may itself embody one or more of these devices.

In some embodiments, the processor 302 may be disposed in communication with one or more memory devices (e.g., RAM 313, ROM 314, etc.) via a storage interface 312. The storage interface may connect to memory devices including, without limitation, memory drives, removable disc drives, etc., employing connection protocols such as serial advanced technology attachment (SATA), integrated drive electronics (IDEs), IEEE-1394, universal serial bus (USB), fiber channel, small computer systems interface (SCSI), etc. The memory drives may further include a drum, magnetic disc drive, magneto-optical drive, optical drive, redundant array of independent discs (RAIDs), solid-state memory devices, solid-state drives, etc.

The memory devices may include a memory storage 315, including, without limitation, an operating system 316, user interface 317, web browser 318, mail server 319, mail client 320, user/application data 321 (e.g., any data variables or data records discussed in this disclosure), etc. The operating system 316 may facilitate resource management and operation of the computer system 301. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 317 may facilitate display, execution, interaction, manipulation, or operation of program components through textual or graphical facilities. For example, user interfaces may provide computer interaction interface elements on a display system operatively connected to the computer system 301, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, JavaScript, AJAX, HTML, Adobe Flash, etc.), or the like.

In some embodiments, the computer system 301 may implement a web browser 318 stored program component. The web browser may be a hypertext viewing application, such as Microsoft Internet Explorer, Google Chrome, Mozilla Firefox, Apple Safari, etc. Secure web browsing may be provided using HTTPS (hypertext transfer protocol secure), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 301 may implement a mail server 319 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 301 may implement a mail client 320 stored program component. The mail client may be a mail viewing application, such as Apple Mail, Microsoft Entourage, Microsoft Outlook, Mozilla Thunderbird, etc.

In some embodiments, computer system 301 may store user/application data 321, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of any computer or database component may be combined, consolidated, or distributed in any working combination.

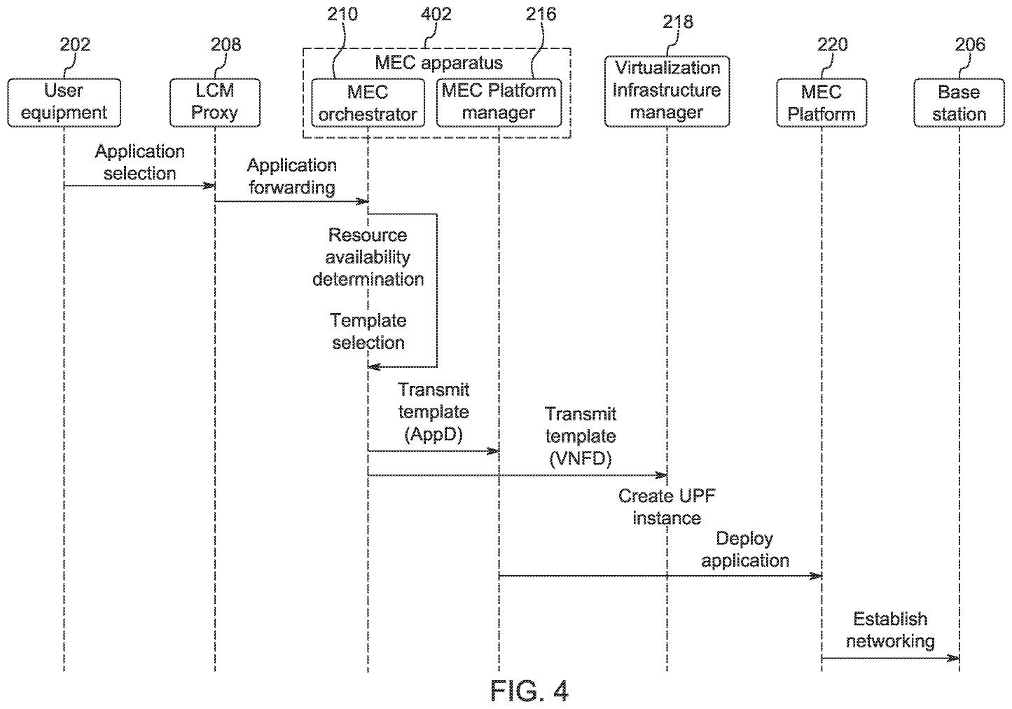

FIG. 4 illustrates a signal flow diagram in accordance with the embodiments of this disclosure. This signal flow diagram represents steps equivalent to the steps earlier described in the context of FIG. 1. However, the signal flow diagram is presented for a better understanding of the functions performed by various entities that are illustrated in the context of FIGS. 2(a) and 2(b). Therefore, the detailed steps as described in the context of FIG. 1 are not repeated in the context of FIG. 4 for the purposes of brevity and to avoid redundancy.

In additional to the entities already illustrated in FIGS. 2(a) and 2(b) and explained earlier, a MEC apparatus 402 is shown in FIG. 4. The MEC apparatus 402 may include the MEC orchestrator 210 and MEC platform manager 216. Although the MEC orchestrator 210 and MEC platform manager 216 are shown as components of the MEC apparatus 402, other variations are also possible. For instance, the MEC apparatus 402 may include any combination of the entities illustrated in FIG. 4. In an exemplary scenario, the VIM 218 may additionally be a part of the MEC apparatus 402. The MEC apparatus 402 may also include additional entities that may or may not be illustrated in FIGS. 2(a), 2(b), and 4 depending on the design requirements of a communication network to implement the features disclosed herein.

In another embodiment, the MEC apparatus 402 may not necessarily include the above configuration but may at least include a processor and a memory that stores computer-executable instructions. The instructions when executed, cause the processor to create, based on a deployment template, an instance of a user plane function (UPF) corresponding to an application, in an edge site in proximity to the UE. Herein, the application is being executed on a user equipment (UE). Further, the deployment template may be selected by the processor in the MEC apparatus 402 based on determining a requirement and an availability of the network resources required by the application. Further in this embodiment, the processor in the MEC apparatus 402 may deploy the created instance of the UPF in a communication network associated with the MEC apparatus 402.

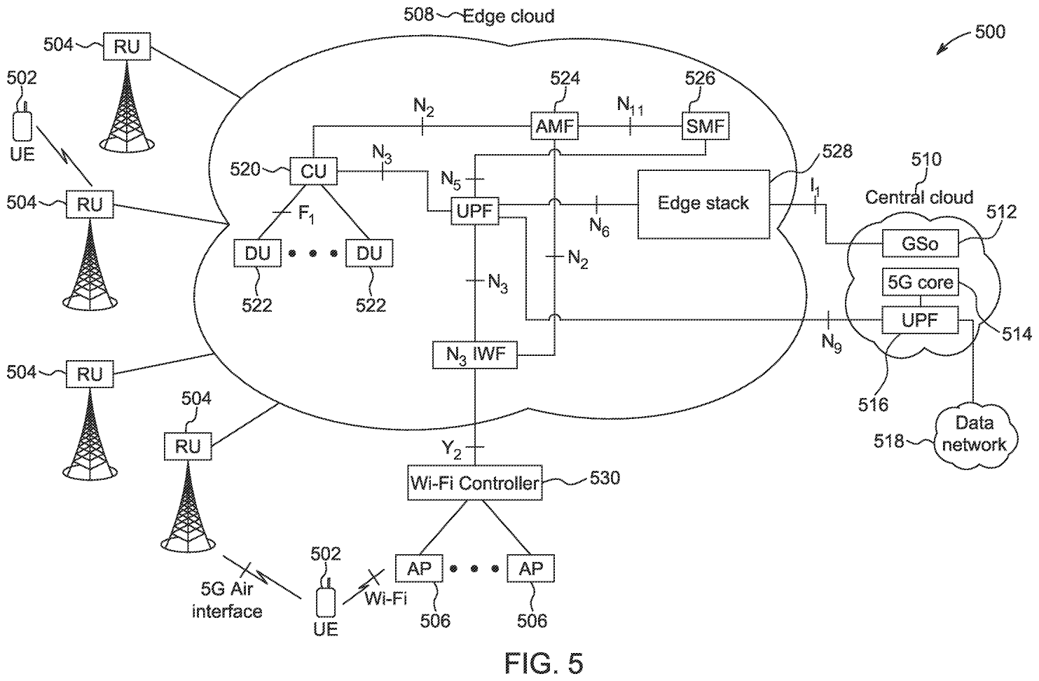

According to some other embodiments of this disclosure, application specific UPFs may also be created by using a relatively more privatized model instead of using a purely telecom-centric model, as described above. The privatized model is illustrated in FIG. 5. For instance, instead of using standardized infrastructure such as the base station or other network elements or nodes provided by a telecom operator, application specific UPFs may also be created by using third-party infrastructure.

The method steps/signal flows described in FIGS. 1 and 4 as well as physical entities described in FIGS. 2(a) and 2(b) may also be suitable for implementing the privatized model. However, the privatized model may differ from the telecom-centric model defined in FIGS. 1, 2(a), 2(b), and 4 in a manner that a strict requirement of standardizing the network protocols and entities may not be present in the privatized model. In one example, the telecom-centric model may require different vendors to provide different components/nodes of the network while in the privatized mode, all the nodes may be provided by a single vendor. Consequently, since the nodes are provided by a single vendor, they may be geographically in proximity to each other and need not be separated by large distances. Additionally, the network may follow protocols defined by the vendor itself instead of following 3GPP defined protocols.

In another example, from a deployment perspective, since a private enterprise may not necessarily have huge infrastructure resources to accommodate all the network nodes in the network, data plane nodes may be accommodated within the private enterprise and remaining control and management nodes may be maintained outside the private enterprise by a third-party cloud service.

In the example illustrated in FIG. 5, a private enterprise is represented as “edge cloud” (similar to Edge-X™) and a third-party cloud provider is illustrated as “central cloud”. Here, the MEC orchestrator 210 [referred here as Global Service Orchestrator (GSo) 512 ] described in the context of FIG. 2(a) is included in the central cloud along with the UPFs and 5G core components. However, the applications are deployed in the edge cloud. The signal flow is still the same in this scenario, as described in the context of FIGS. 1 and 4.

FIG. 5 illustrates a privatized communication network 500, which includes UE 502 (similar to UE 202 or 204) that may communicate with one or more radio units (RUs) 504 and/or one more Wi-Fi access points 506. Additionally, an edge cloud 508, which is similar in functioning as the edge site 212 of FIG. 2(b) is also illustrated. Here, the Wi-Fi access points 506 may be in communication with the edge cloud 508 via a Wi-Fi controller 530. In an example, the Wi-Fi access points 506 may act as forwarding agents and the Wi-Fi controller 530 may act as a control agent for any forwarding and control data communicated from and the UE 502 by the edge cloud 508. Here, the edge cloud 508 may be owned or operated by a private entity (not shown) and not necessarily a telecom operator. The edge cloud 508 may include any subset of, or all the components included in the edge site 212 and thus, may be synonymous with Edge-X™. Further, the UE 502 may access the edge cloud via the one or more RUs 504 and the one or more Wi-Fi access points 506 to which the UE 502 is connected. In this scenario, the edge cloud 508 may also be in communication with a central cloud 510.

The central cloud 510 may be a third-party cloud service such as, but not limited to, Amazon Web Services® or Google Cloud Platform™ or a similar service. The central cloud 510 may include, but not limited to, a GSo 512 (or MEC orchestrator 210), 5G core components 514, and one or more UPFs 516 that connect the central cloud 510 to an external data network 518.

As discussed above, the edge cloud 508 may be equivalent to the edge site 212 (or Edge-X™), which may at least include equivalent entities or components as illustrated in FIGS. 2(a) and 2(b). In one example, the edge cloud 508 may include a control unit (CU) 520, one or more data units (DUs) 522, and an Access and Mobility Management Function (AMF) 524, and a session management function (SMF) 526 the functions of which, are known in the art. The edge cloud 508 may also include an edge stack 528 that may be equivalent in its functions to the MEC orchestrator 210 of FIG. 2.

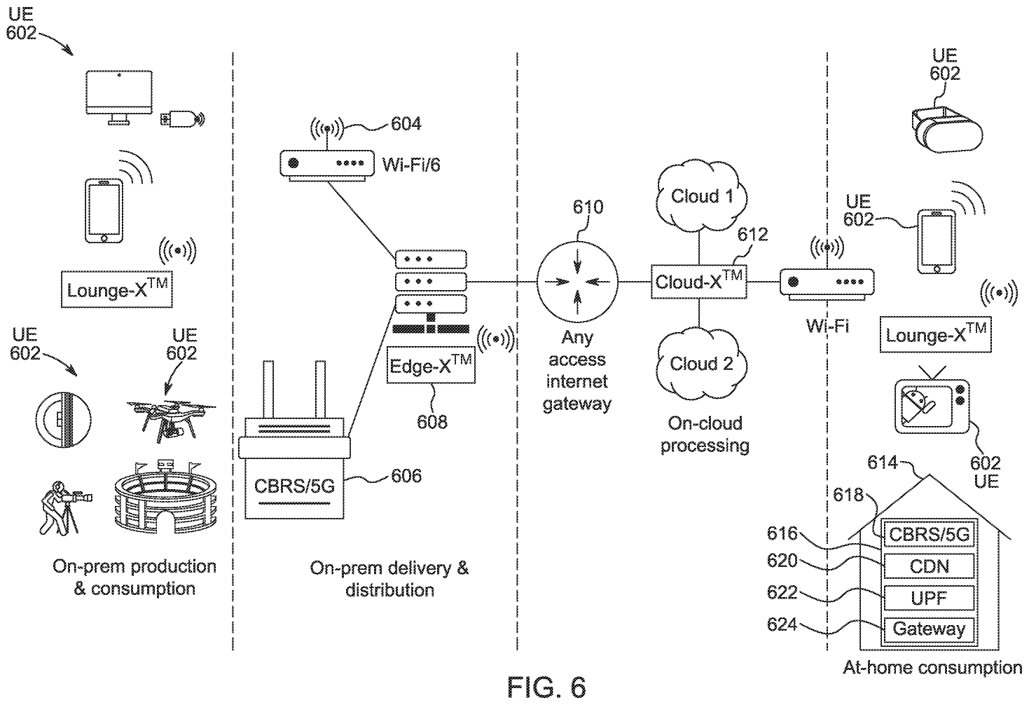

FIG. 6 represents an exemplary scenario of a privatized model, in accordance with the embodiments of this disclosure. One or more UEs 602 (equivalent to UE 202) may access an edge site (or Edge-X™) via a Wi-Fi 6 access point 604 and/or a Citizens Broadband Radio Service (CBRS) 5G access point 606. Here, the UE 602 and the access points (604, 606) may be located on the same premises as the Edge-X™ 608. A skilled person would appreciate that any network may be implemented according to the embodiments of the invention without any limitation.

Additionally, one or more other UEs such as, but not limited to, a smartphone, a TV, a football with on-board sensors and paired with a smartphone, or any other UE as discussed previously, may be located remotely from the above-mentioned access points. For example, the UE may be located at a remote premise such as a home 614 which is at a location different from that of the Edge-X™ 608. The UE may thus, be able to remotely access the Edge-X™ (or edge site 212) via either the Wi-Fi 6 access point and/or the CBRS 5G access point. In one example, the home 614 may include a local Edge-X™ called Edge-X™ lite 616. The Edge-X™ lite 616 may include similar components and functions as included in Edge-X™ 608 but with relatively lesser computational capabilities to support a smaller number of UEs accessing the Edge-X™ lite 616 compared to a large number of UEs accessing the Edge-X™ 608. For instance, the Edge-X™ lite 616 may include a CBRS/5G 618 access point, which may be equivalent in functions to the CBRS/5G 606 access point but with relatively lesser computational capabilities to support home consumption. The Edge-X™ lite 616 may also include one or more of, but not limited to a CDN function 620, a UPF function 622, and a gateway function 624 (as known in the art) with lesser computational capabilities as compared to the corresponding functions in the Edge-X™ 608.

Further, the Edge-X™ 608 may be connected to a Cloud-X™ platform 612 via an access internet gateway 610. The Cloud-X™ 612 may include or be connected to one or more third-party cloud service providers—cloud 1, cloud 2 and so on. As explained in the context of FIG. 5, the Cloud-X™ 612 may host one or more of 5G core network components, UPFs, and the MEC orchestrator 210.

In the above example, a user using the UE may be consuming a streamed content such as a football match in a stadium. The stadium may include 5G and Wi-Fi infrastructure on the same premises (on-prem delivery) to enable the user to access the Edge-X™ via one or more of 5G and Wi-Fi access points. The embodiments of the present disclosure enable the user to seamlessly watch the streamed content by executing the method described in the context of FIGS. 1, 2(a), 2(b), and 4. The Lounge-X™ application on the UE may constantly monitor the requirements of the resource-intensive and/or latency-sensitive applications running on the UE. Accordingly, Lounge-X™ may communicate with the Edge-X™ through a control loop with the objective of creating specific UPFs for the UE to access the Edge-X™ via such UPFs, in accordance with the embodiments of this invention.

In this example, Lounge-X™ may also monitor the resource requirements of the applications running on the UE dynamically (in real-time) as the content streams on the UE. The Edge-X™ can adjust the creation of the UPFs accordingly. Further, the Edge-X™ may also employ load balancing based on the resource requirements communicated by the Lounge-X™. For instance, if Edge-X™ determines that the cellular network (e.g. 5G network) bandwidth may not be sufficient to deliver a streaming content to the UE, it may distribute the content to the UE using both the cellular and Wi-Fi networks or using the Wi-Fi network alone, which may have a higher bandwidth than the cellular network. These techniques, in accordance with the embodiments of this disclosure, may ensure, a seamless user experience while watching the streamed content.

In the above example, the embodiments of the invention may be useful in prioritizing certain types of traffic or for certain users or based on any other criteria depending on the system design. For instance, if an influencer is watching the football match, the above-described embodiments may create a specific network slice for that influencer and prioritize the traffic to or from their UE, to provide a seamless content viewing experience.

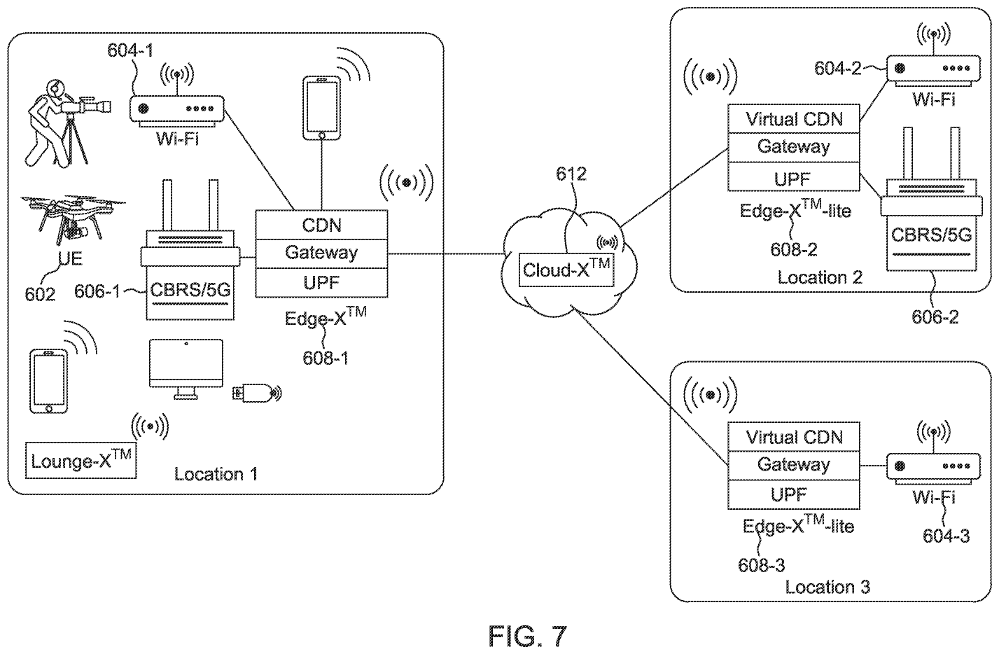

FIG. 7 illustrates several networks at different locations (e.g. location 1, location 2, location 3, and so on) in communication with each other. Each of these networks may include an Edge-X™, which may further include various functions such as CDNs or virtual CDNs, UPFs, and gateway functions along with one or more integrated Wi-Fi access points (e.g. 604-1, 604-2, 604-3 and so on) and/or one or more integrated CBRS access points (606-1, 606-2, 606-3 and so on). In the illustrated example, location 1 may represent an enterprise location such as a stadium, and locations 2 and 3 may represent geographically separated home environments. The Edge-X™ in each of these networks may be in communication with one or more UEs 602 in the corresponding network.

Here, the Edge-X™ 608-1 in location 1 may include various functions such as a corresponding CDN function, a gateway function, and a UPF function. Additionally, the CBRS access point 606-1 and a Wi-Fi access point 604-1 may also be integrated with the Edge-X™ 608-1. In locations 2 and 3, one or more functions corresponding to location 1 may be included but with significantly lesser computational capabilities. Additionally, locations 2 and 3 may include virtual CDNs instead of a (physical) CDN located in location 1. Location 2 may additionally include a CBRS/5G access point 606-2 to support 5G communication with the Cloud-X™ 612. A person skilled in the art would understand that any number of networks and their internal components may be possible depending on the design requirements.

Each of these networks may be remotely located with respect to each other and individually function in accordance with the embodiments described earlier. For instance, each network may be located at location 1, location 2, and location 3, respectively which may be geographically separate and/or distant from each other. However, all the illustrated networks may have a common cloud service provider, illustrated as Cloud-X™ 612. This implies that any common data related to 5G core components, MEC orchestrator 210, or any common UPFs may be collectively stored at the Cloud-X™ 612.

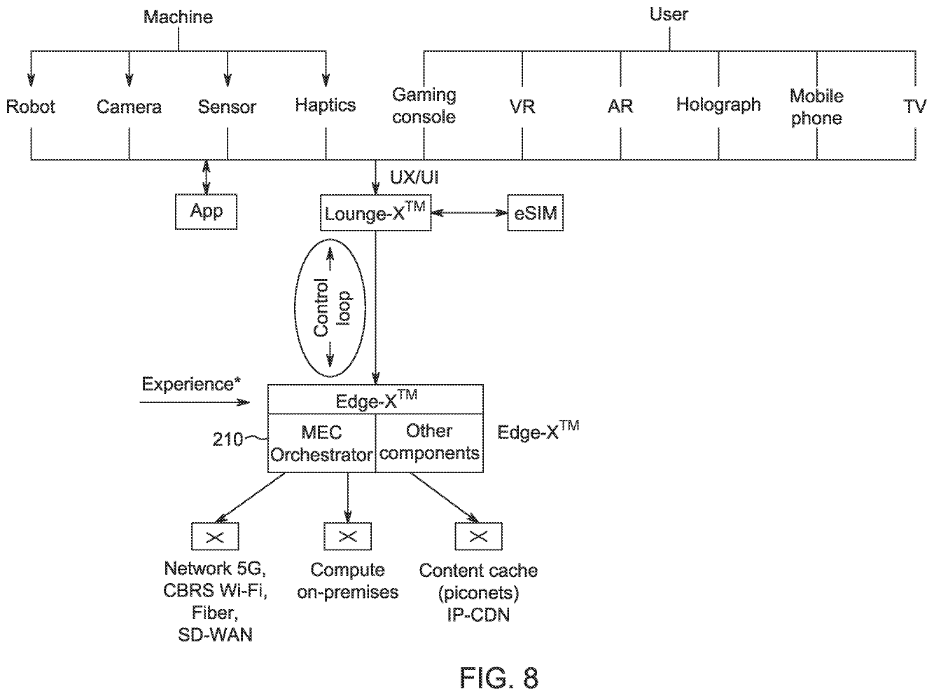

Further, FIG. 8 illustrates a relationship between Lounge-X™ and Edge-X™ platforms, as described earlier in this disclosure. Further, a user of the UE may use the Lounge-X™ platform in the UE to run several applications that need resource management, in accordance with the embodiments of this disclosure. The Lounge-X™ may be used in conjunction with an eSIM, to access Edge-X™ in the manner described in the context of FIG. 1. These applications may receive additional data such as but not limited to, robotic gestures, camera, sensor data, haptics feedback and so on depending on the type of application and the required inputs. Accordingly, the Lounge-X™ application may receive the above-mentioned data as inputs and interact with Edge-X™ based on the received inputs.

Here, the Lounge-X™ may be integrated with an eSIM functionality, in the manner described in FIG. 1. Both Edge-X™ and Lounge-X™ may be in communication with each other through a control loop, which may be a virtual connection between these platforms. Some functionalities of the Lounge-X™ may be managed by Edge-X™ by way of the explanation provided in this disclosure. Further, Edge-X may interact with other components in the network such as content cache, compute infrastructures, and several networks such as 5G networks, Wi-Fi networks, WLAN networks and so on.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD-ROMs, DVDs, flash drives, disks, and any other known physical storage media.

The terms “including,” “including,” and “having,” as used in the claim and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation. Additionally, it should be understood that the various embodiments of the networks, devices, and/or modules described herein contain optional features that can be individually or together applied to any other embodiment shown or contemplated here to be mixed and matched with the features of such networks, devices, and/or modules.

While the invention has been described with respect to a limited number of embodiments, those skilled in the art, having benefit of this disclosure, will appreciate that other embodiments can be devised which do not depart from the scope of the invention as disclosed herein.

I/We claim:

1. A method for resource management for an application in a communication network, the method comprising:
creating, based on a deployment template, an instance of a user plane function (UPF) corresponding to an application, in an edge site of the communication network, wherein the application is being executed on a user equipment (UE) in the communication network; and
deploying the created instance of the UPF in the communication network.

2. The method of claim 1, further comprising:
receiving, from the UE via a lifecycle management (LCM) proxy node, a request for network resources required by the application;
determining a requirement and an availability of the network resources; and
selecting the deployment template based on determining the requirement and the availability of the network resources.

3. The method of claim 2, further comprising selecting the edge site based on one or more of a proximity of the edge site to the UE, the availability of the network resources on the edge site, and a hardware requirement of the application.

4. The method of claim 1, wherein determining the availability of the network resources comprises determining the availability of the network resources in the edge site based on a mapping between one or more applications and their resource requirements.

5. The method of claim 1, wherein selecting the deployment template based on the determination comprises:
selecting the deployment template if it is determined that the network resources are available; and
sending an error message to the UE, if it is determined that the network resources are not available.

6. The method of claim 1, wherein the deployment template comprises:
an application descriptor (AppD) that indicates the network resources required by the application, and
a virtual network function description (VNFD) that indicates:
one or more parameters that define a configuration and deployment specification of a virtual network function (VNF) associated with the VNFD;
one or more parameters that define a configuration and deployment specification of the instance of the UPF; and
one or more configuration parameters for one or more nodes in the communication network.

7. The method of claim 6, further comprising configuring the one or more nodes based on a virtual network function descriptor (VNFD) corresponding to the VNF.

8. The method of claim 1, further comprising establishing networking between one or more nodes in the communication network, wherein establishing the networking comprises connecting each of the created instances of the UPFs to the one or more nodes to enable a UE executing the application to access the UPFs.

9. The method of claim 1, further comprising:
performing an analysis of usage patterns and resource utilization of the application using one or more of an Artificial Intelligence (AI)/Machine Learning (ML) models; and
providing one or more contextual content recommendations based on the usage patterns.

10. The method of claim 4, further comprises reconfiguring one or more of the one or more nodes based on the created application to resource mapping.

11. The method of claim 1, wherein the application is based on one or more of augmented reality, virtual reality, and mixed reality, and further wherein, the application comprises one of:
an interactive streaming application,
a gaming application comprising an interactive gaming application or a cloud gaming application, and
a remote rendering application such as a connected cars application, a holographic application, an Industrial Internet of Things (IIoTs) application, and a haptics-based application.

12. A communication network comprising:
a virtual infrastructure manager (VIM) configured to create, based on the deployment template, an instance of a user plane function (UPF) corresponding to an application, in an edge site of the communication network, wherein the application is being executed on a user equipment (UE) in the communication network; and
a platform manager configured to deploy the created instance of the UPF in the communication network.

13. The network of claim 12, further comprising:
the user equipment (UE) configured to transmit a request for the network resources required by the application being executed on the UE;
a lifecycle management (LCM) proxy node configured to:
receive, from the UE, the request for the network resources required by the application; and
transmit, to an MEC orchestrator, the request for the network resources required by the application.

14. The network of claim 12, further comprising:
the MEC orchestrator configured to:
determine a requirement and an availability of the network resources required by the application;
select the deployment template based on the determination; and
transmit the selected deployment template to the VIM and the platform manager.

15. The network of claim 12, wherein the edge site is selected based on one or more of a proximity of the edge site to the UE, the availability of the network resources on the edge site, and a hardware requirement of the application.

16. The network of claim 14, wherein the MEC orchestrator is further configured to:
select the deployment template if it is determined that the network resources are available; and
send an error message to the UE, if it is determined that the network resources are not available.

17. The network of claim 12, wherein the deployment template comprises one or more of:
an application descriptor (AppD) that indicates the network resources required by the application;
a virtual network function description (VNFD) that indicates:
one or more parameters that define a configuration and deployment specification of a virtual network function (VNF) associated with the VNFD;
one or more parameters that define a configuration and deployment specification of the instance of the UPF; and
one or more configuration parameters for one or more nodes in the communication network.

18. The network of claim 14, wherein the MEC orchestrator is further configured to determine the availability of the network resources in the edge site based on a stored mapping between one or more applications and their resource requirements.

19. A multi-edge computing (MEC) apparatus, comprising:
a processor; and
a memory storing computer-executable instructions that when executed, cause the processor to:
create, based on a deployment template, an instance of a user plane function (UPF) corresponding to an application, in an edge site in proximity to the UE, wherein the application is being executed on a user equipment (UE); and
deploy the created instance of the UPF in a communication network associated with the MEC apparatus.

20. The apparatus of claim 19, wherein the computer-executable instructions further cause the processor to:
receive, from a user equipment (UE), a request for network resources required by an application;
determine a requirement and an availability of the network;
select the deployment template based on determining the requirement and the availability of the network resources.
